(19) United States
(12) Patent Application Publication
(10) Pub. No.: US 2007/0048558 A1
(43) Pub. Date: Mar. 1, 2007

(54) Molecular stimulator fuel cell and H.sub.2 O.sub.2 generator

(76) Inventor: Edward Edwin Routery, Gilbert, AZ (US)

Correspondence Address: EDWARD E. ROUTERY, 1123 E BETSY LN, GILBERT, AZ, 85296, US

(21) Appl. No.: 11/217,238

(22) Filed: Sep. 1, 2005

(51) Int. Cl. H01M 8/00

(52) U.S. Cl. 429/13; 429/34

(57) ABSTRACT

a method for performing work comprising the steps of providing (h.sub.2 o.sub.2) product, the release of energy, to perform work. power generation incorporating an anode along with reduction of but not limited to a hydrogen peroxide solution, causing an electric current to flow from the anode to the cathode through the electrolyte, which is contained within the hydrogen peroxide solution

### REFERENCES CITED

[Referenced by]

u.s. patent documents

| | | | |
|---|---|---|---|
| 3969899 | July, 1976 | Nakazawa et al. | 60/670. |
| 4067787 | January, 1978 | Kastening et al. | 205/466. |
| 4430176 | February, 1984 | Davison | 204/84. |
| 4455203 | June, 1984 | Stucki | 205/468. |
| 4897252 | January, 1990 | Cochran et al. | 423/591. |
| 4985228 | January, 1991 | Kirksey | 423/584. |
| 5055286 | October, 1991 | Watanabe et al. | 423/584. |
| 5112702 | May, 1992 | Berzins et al. | 429/17. |
| 5180573 | January, 1993 | Hiramatsu et al. | 423/584. |
| 5215665 | June, 1993 | Crofts et al. | 210/638. |
| 5401589 | March, 1995 | Palmer et al. | 429/13. |
| 5705040 | January, 1998 | Johnsson et al. | 203/93. |
| 5711146 | January, 1998 | Armstrong.et al. | 60/218. |
| 11052175 | | Routery | |

Hydrogen production from hydrolytic oxidation of organosilanes using a cationic oxorhenium catalyst.

Brown laboratory, department of chemistry,

Purdue University, 560 oval drive, west Lafayette, Ind. 47907 received Jun. 12, 2005.

### SUMMARY OF THE INVENTION

The addition of a Molecular Stimulator, such as but not limited to U.S. patent application Ser. No. 11/052,175 controls chemical reaction rates, electrochemical reaction rates and their efficiencies. The present invention demonstrates one such advancement made possible by incorporating Molecular Stimulation in the field of fuel cells.

### BACKGROUND OF THE INVENTION

Chemical reactions, specifically but not limited to electrochemical reactions, take place at a rate, cost and efficiency, less then theoretically possible. fuel cells and oxidant generation methods, including but not limited to, h2o2 production from, h2o with an anode a cathode and electric energy, as well as the generation of electric energy from anodic reactions which include h2o2 an anode and a cathode. A few of such means providing electrochemical reactions are listed in the patents referenced by this application. Examples: a standard Hoffman apparatus demonstrates when voltage is applied to the system, water is broken down into hydrogen, and oxygen, the relative amounts of each gas is 2:1. Electrolysis of h2o cathode: 2h2o+2e− ? h2(g)+2oh−eo=−0.82 v at ph 14, −0.41 v at ph 7, 0.00 v at ph 0 anode: 2h2o? o2(g)+4h+ +4e−eo=−0.41 v at ph 14, −0.82 v at ph 7, −1.23 v at ph 0 2h2o? 2h2(g)+o2(g) eo=−1.23 v at any ph must supply at least 1.23 v to electrolyze water. Add an electrolyte to increase electrical conductivity. The h2o2 cell a dissolved fuel cell, operates at room temperatures. The oxygen electrodes contain Raney silver and the hydrogen electrodes contain Raney nickel as the catalyst. The fundamental voltage is over 90% of the theoretically attainable voltage of 1.23 volt. The electrodes are double-skeleton catalyst electrodes. One amp-hour is 3600 coulombs, 0.000277 amps/sec. 96,000 amps is 26.6 amps/sec. 96 kwh. 360 volts at 266.6 amps. Aluminum yields 1.8 kwh/lb. 300 economical miles 75 mph. 400 watts/mile is 400 amp hrs. 30 kw or 30 k amp hrs/3,600 is 8.33 amps/sec/equals 0.0046 lbs/sec.

### DETAILED DESCRIPTION OF THE PREFERRED EMBODIMENT

When h2o2 is required, an h2o vessel with an anode, and cathode, and catalysis, and a molecular stimulator such as but not limited my referenced # 11052175. To control reaction rate of electrolysis to h2o2, then to a high % by mass h2o2 preferably 98% by mass and stored. When externally supplied h2o2 is stored on board, the production of oxidant is not required and thus eliminated. The h2o2 is then pumped in metered quantities, to a reactor vessel compartment at the lowest most quadrants of the reactor to a height preferred above the base of the compartment. the oxidant height is then metered at the flow rate required, through the 140 porous cathodes, 0.250 inch thick and 1.250 inches in diameter and but not limited to the 140 very porous insulating disks being 0.250 inches thick and 1.200 inch diameter, and electrode disks setting between the anodes and the insulators. to first wet the anodes composed of but not limited to 0.0034 aluminum spheres rather then powders which tend to pack and cake, 0.0000275 inch surface equals 0.9755 surface area per 0.003 height when 140 anodes equals 130 square inches of surface area exposed. when use of solids are the source available then 1.125 inch diameters with 0.99351 surface area faces, in lengths to fit, weights as required each for a total weight of anodes to be consumed, sitting on the sharp surfaces of the grinding, scrubbing disks, which are not required when using spheres for anode materials but are porous electrical connection contact electrode cups draining the sludge back to the oxidant compartment for cooling and separation.

The duration of the wetted anode faces determines the wattage output, controlled by load. The anodes and cathodes are series connected for 350 volt output. The design parameters of this prototype called for, least expensive most available materials. As aluminum bars were more easily available we chose for the prototype but not the preferred material the 1.125 diameter 12 foot lengths 14 lb mass was chosen. With retail cost of $2.30/lb. 8.888 oz equals one kwh. 70 lbs equals 1,120 ozs. With 126 kWh available at 350 volts and 360 amps equaling 4 hours of 31.5 kw continues load. The containment of each cell is a non-conductive, non-porous material. The molecular stimulator stimulates the anodes and or the scrubbing disks such that the aluminum bar faces sitting on the sharp surface or spheres on smooth surfaces are washed and or scrubbed by the molecular stimulation energy. A stimulation rate to maintain a clean unoxidized surface to the oxidant. The % by mass of the oxidant needed, 20 lbs to 200 lbs, 2.5 gallon to 25. The voltage is constantly 0 or 350 volts, and amps is controlled by the flow of oxidant, from no load, no material, to full load. Estimates of 5.5 cents per mile are realistic once supply equals demand. The total cost of ownership and operation of an aluminum/h2o2 vehicle should range between 4.5 and 6 cents/mile. An electric car with 350 v of power during cruising will draw from 2 amps to 360 amps, while accelerating. Ac motors 16.4″, by 13.50″, 234.35 lbs, 312 volt.eff 93%. peak/maximum ft-lb 177, amps 250 rms, rpm 8 k, hp 105, kw 78, continuous ft-lb 40.6, amps 108 rms, rpm 8 k, hp 46, kw 34.

The volume and flow rate of the oxidant used to wet the surface between the anode and cathode is dependant on the % by mass of the oxidant and the load conditions meaning watts required per second. Hydrogen peroxide as the oxidant, increases reliability and efficiency, reducing noise, and obscuring carrier signatures relative to conventional fuels. The replenish able products reduce logistic problems in the distribution, transportation and supply of energy. The energy content of h2o2/aluminum is approximately one-half the energy content of conventional fuels, but efficiencies in extracting the energy is approximately three times greater. 98% by mass h2o2 equals 1824 degrees f. this summary, of the invention is not intended to be limiting, but only examples of the inventive features, which are defined in the claims.

### DESCRIPTION OF THE DRAWINGS

Drawing 1. A sectional view showing the molecular stimulator according to a first embodiment of the present invention, accompanied by an enlarged view showing a main portion of the molecular stimulator. (1, 2, 3) energizing coil and electrodes for shield or hydraulic actuation medium adjustment of reservoir core target (4, 5) the energy reservoir core target, transmission medium for energy being transmitted being the frequency best suited for molecular stimulation of molecules to be energized (6) material best suited for shielding (5) as well as from (7) material best suited to insulate energy transfer one from the other (8, 8a) a induction coil surrounding a portion of (4) with, a gas tight, pressure tight, energy tight seal between (7) and (9) being machined to attach to fuel cell chamber, (10) insulation, (11) adapter for adding molecular stimulator output to fuel cell chamber. Wherein satisfactory chemical reactions are maintained by but not limited to scrubbing and flushing the anode faces.

### BRIEF DESCRIPTION OF THE DRAWINGS

Dwg 1. this molecular stimulator provides chemical reaction rate control.

Dwg 2.

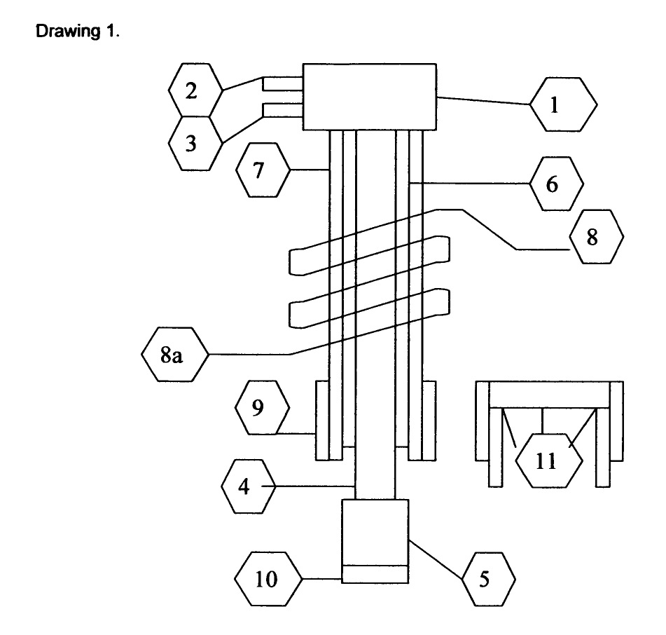

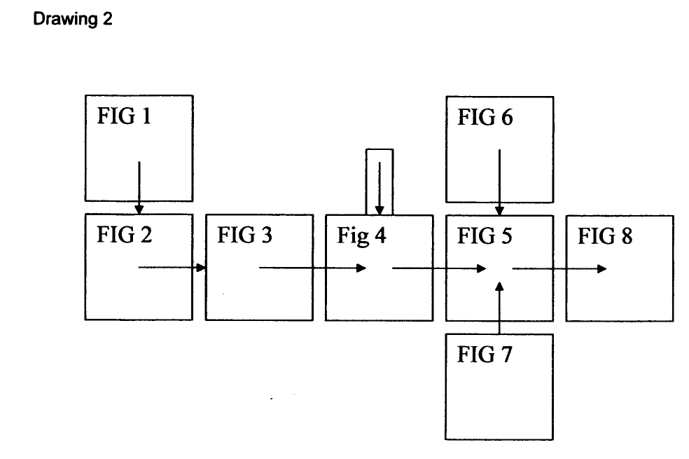

FIG. 1. Is a electrical energy supply

FIG. 2. Is a vessel for storage and conversion of h2o to h2o2 containing an anode, a cathode and a catalysis of choice.

FIG. 3. Is a enhancer for increasing the h2o2 output of FIG. 1 vessel

FIG. 4. Is a storage vessel for storing the 98% by mass h2o2 provided by either FIG. 3 enhancer or externally supplied.

FIG. 5. Is the pump transporting oxidant to reactor cells to just short of the anodes.

FIG. 6. A control device for actuating the scrubbing surface and or on demand cleaning chemical flushing with but not limited to chemical types listed in the claims.

FIG. 7. A oxidant controller receiving watt information to adjust flow rate to wet the anode. First wetting the anode then allowing the sludge from the reaction to separate from the anodes through a filter with oxidant returning to the supply line.

FIG. 8. Reactor fuel cell vessel.

What is claimed is:

1. a method for performing work with the assistance of a molecular stimulator or device with similar capabilities, as well as in the anode, cathode, compartment of the energy release container and operating at various frequencies for oxide removal wherein the products release energy; and direct the released energy to perform work.

2. The method of claim 1, wherein providing said (h.sub.2 o.sub.2) comprises electrolytic conversion of (h.sub.2 o.) to form hydrogen peroxide (h.sub.2 o.sub.2).

3. The method of claim 1, wherein the released energy drives a land vehicle.

4. The method of claim 1, wherein the released energy powers a spacecraft.

5. The method of claim 1, wherein the released energy powers an aerial vehicle.

6. The method of claim 1, wherein the released energy drives a maritime vessel.

7. The method of claim 1, wherein the maritime vessel comprises an undersea delivery vehicle.

8. The method of claim 1, wherein providing said product consisting of (h.sub.2 o.sub.2) comprises storing said (h.sub.2 o.sub.2) product in a tank prior to committing said product into fuel cell container area.

9. The method of claim 1, comprising directing said product to power a fuel cell.

10. The method of claim 1, wherein the performed work replaces work performed by an internal combustion engine.

11. The method of claim 1, wherein the performed work replaces work performed by a diesel engine.

12. A power system comprising a product consisting essentially of:
(h.sub.2 o.sub.2) wherein energy is released; and means for producing work from the released energy.

13. The method of claim 1, wherein a water-soluble coating remover composition comprising:
(a) From about 25 to about 94 weight percent of gamma.-butyrolactone;
(b) From about 1 to about 40 weight percent of and organic acid; and
(c) At least about 5% weight in water.

14. One formula for method of claim 13. Wherein the acid has the formula rcooh in which r is selected from the group consisting of hydrogen c.sub.1-c.sub.10 alkyl, halogen-substituted c.sub. 1-c.sub. 10 alkyl, hydroxy-substituted c,sub.4-c.sub.6 alkyl, and c.sub.4-c.sub.6 cycloalkyl.

15. The composition of claim 13 wherein an alkali metal salt of said organic acid is used instead of or in addition to acids.

16. The composition of claim 1 wherein the organic acid is selected from the group consisting of formic, acetic, chloroacetic, glycolic, and citric.

17. The composition of claim 13 wherein the organic acid is formic acid.

18. The composition of claim 13 wherein the acid is designed
specifically
for its end use strength and chemistry.

19. The method of claim 1, wherein a molecular stimulator or device with similar capabilities producing vibration energy, cleans the oxides from anode and or cathodes.

20. The method of claim 1, wherein a molecular stimulator or device with similar capabilities tunable vibration stirs the hydrogen peroxide at variable rates to accelerate or decelerate the reaction rate of the fuel cell.
